(19) United States
(12) Patent Application Publication
(10) Pub. No.: US 2026/0268938 A1
(43) Pub. Date: Sep. 10, 2026

(54) VIDEO GENERATION METHOD AND DEVICE, AND STORAGE MEDIUM

(71) Applicant: Beijing Zitiao Network Technology Co., Ltd., Beijing (CN)

(72) Inventors: Yijing LIN, Beijing (CN); Yingwei ZHENG, Beijing (CN)

(21) Appl. No.: 19/557,054

(22) Filed: Mar. 4, 2026

(30) Foreign Application Priority Data
Mar. 6, 2025 (CN) 202510264838.X

(51) Int. Cl. G11B 27/031; G10L 15/08

(52) U.S. Cl. CPC G11B 27/031; G10L 15/08

(57) ABSTRACT

The present disclosure provides a video generation method and apparatus, a device, and a storage medium. The method includes: obtaining a reference video; receiving at least one piece of media content and description information of a video content object; and generating a video based on the reference video, the at least one piece of media content, and the description information of the video content object, where the video displays object information of the video content object, and the video comprises a plurality of video segments, the plurality of video segments have a correspondence with a plurality of text segments.

### CROSS-REFERENCE TO RELATED APPLICATION

The present application claims the priority to Chinese Patent Application No. 202510264838.X, filed on Mar. 6, 2025, the entire disclosure of which is incorporated herein by reference as a portion of the present application.

### TECHNICAL FIELD

The present disclosure relates to a video generation method and apparatus, a device, and a storage medium.

### BACKGROUND

With the continuous development of video generation technology, functions related to video generation have become more diverse, for example, generating a video by using a video template.

To satisfy people’s diverse requirements for video generation functions, there is an urgent technical problem regarding how to further enrich the way of generating a video.

### SUMMARY

To solve the above problem, embodiments of the present disclosure provide a video generation method and apparatus, a device, and a storage medium.

The present disclosure provides a video generation method, including:

obtaining a reference video;

receiving at least one piece of media content and description information of a video content object; and

generating a video based on the reference video, the at least one piece of media content, and the description information of the video content object,

where the video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

In an optional implementation, part or all of video editing effects of the reference video are presented in a video.

In an optional implementation, the obtaining the reference video includes:

receiving video link information entered by a user, and obtaining the reference video based on the video link information.

In an optional implementation, the obtaining the reference video includes:

displaying a first page, and obtaining the reference video based on a plurality of pieces of video content displayed on the first page.

In an optional implementation, the generating the video based on the reference video, the at least one piece of media content, and the description information of the video content object includes:

obtaining a script recognition result of the reference video by performing at least one of speech recognition and image recognition on the reference video, where the script recognition result describes a paragraph structure of script content of the reference video;

generating a video script based on at least one of the description information of the video content object and content information extracted from the at least one piece of media content, and based on the script recognition result of the reference video;

determining corresponding video segments for a plurality of text segments corresponding to the video script, respectively, from the at least one piece of media content; and

generating the video based on the video segments respectively corresponding to the plurality of text segments.

In an optional implementation, before the generating the video based on the video segments respectively corresponding to the plurality of text segments, the video generation method further includes:

performing timbre recognition on the reference video to obtain timbre information of the reference video; and

generating, based on the timbre information and a text segment, a speech segment for a video segment corresponding to the text segment, where the speech segment has the timbre information;

and the generating the video based on the video segments respectively corresponding to the plurality of text segments includes:

generating the video based on the video segments respectively corresponding to the plurality of text segments, and a plurality of speech segments corresponding to the video segments.

In an optional implementation, after the generating the video based on the reference video, the at least one piece of media content, and the description information of the video content object, the video generation method further includes:

performing music recognition on the reference video to obtain music information of the reference video; and

adding background music to the video based on the music information.

In an optional implementation, before the determining the corresponding video segments for the plurality of text segments corresponding to the video script, respectively, from the at least one piece of media content, the video generation method further includes:

performing text segmentation on the video script to obtain the plurality of text segments corresponding to the video script, where the plurality of text segments have a preset order relationship.

In an optional implementation, the determining the corresponding video segments for the plurality of text segments corresponding to the video script, respectively, from the at least one piece of media content includes:

cutting the corresponding video segments for the plurality of text segments, respectively, from the at least one piece of media content;

and the generating the video based on the video segments respectively corresponding to the plurality of text segments includes:

concatenating the video segments respectively corresponding to the plurality of text segments to obtain the video based on the preset order relationship.

In an optional implementation, the cutting the corresponding video segments for the plurality of text segments, respectively, from the at least one piece of media content includes:

performing content feature recognition on the at least one piece of media content, respectively, to determine a feature segment having a content feature in the at least one piece of media content; and

cutting at least one feature segment from the at least one piece of media content, and determining a text segment corresponding to the feature segment from the plurality of text segments.

In an optional implementation, before the concatenating the video segments respectively corresponding to the plurality of text segments to obtain the video based on the preset order relationship, the video generation method further includes:

generating, based on a text segment, a speech segment for a video segment corresponding to the text segment,

and the concatenating the video segments respectively corresponding to the plurality of text segments to obtain the video based on the preset order relationship includes:

concatenating the video segments respectively corresponding to the plurality of text segments and having the speech segment to obtain the video based on the preset order relationship.

The present disclosure further provides a video generation apparatus, including:

an obtaining module, configured to obtain a reference video;

a receiving module, configured to receive at least one piece of media content and description information of a video content object; and

a first generation module, configured to generate a video based on the reference video, the at least one piece of media content, and the description information of the video content object,

where the video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

The present disclosure further provides a computer-readable storage medium, where instructions are stored in the computer-readable storage medium, and the instructions, when executed by a terminal device, cause the terminal device to implement the above method.

The present disclosure further provides a video generation device, including a memory, a processor, and a computer program stored on the memory and executable on the processor, where the processor, when executing the computer program, implements the above method.

The present disclosure further provides a computer program product, including a computer program/instruction, where the computer program/instruction, when executed by a processor, implements the above method.

### BRIEF DESCRIPTION OF DRAWINGS

The drawings herein, which are incorporated in this specification and constitute a part thereof, illustrate embodiments consistent with the present disclosure and, together with the description, serve to explain the principles of the present disclosure.

In order to more clearly explain the technical solutions in the embodiments of the present disclosure, the drawings to be used in the description of the embodiments will be briefly introduced below. Obviously, for those of ordinary skill in the art, they may also obtain other drawings according to such drawings without paying any creative effort.

FIG. 1 is a flowchart of a video generation method provided by the embodiments of the present disclosure;

FIG. 2 is a schematic diagram of a video generation page provided by the embodiments of the present disclosure;

FIG. 3 is a schematic diagram of another video generation page provided by the embodiments of the present disclosure;

FIG. 4 is a schematic diagram of another video generation page provided by the embodiments of the present disclosure;

FIG. 5 is a schematic diagram of another video generation page provided by the embodiments of the present disclosure;

FIG. 6 is a schematic diagram of another video generation page provided by the embodiments of the present disclosure;

FIG. 7 is a schematic structural diagram of a video generation apparatus provided by the embodiments of the present disclosure; and

FIG. 8 is a schematic structural diagram of a video generation device provided by the embodiments of the present disclosure.

### DETAILED DESCRIPTION

In order to understand the above objects, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein. Obviously, the described embodiments are part of the embodiments of the present disclosure, but not all of the embodiments.

With the continuous development of video generation technology, functions related to video generation have become more diverse, for example, generating a video by using a video template.

To satisfy people’s diverse requirements for video generation functions, there is an urgent technical problem regarding how to further enrich the way of generating a video.

To this end, the embodiments of the present disclosure provide a video generation method. In the method, firstly, a reference video is obtained, and at least one piece of media content and description information of a video content object are received; then, a video is generated based on the reference video, the at least one piece of media content, and the description information of the video content object. The video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

In the embodiments of the present disclosure, the video can be generated based on the reference video, the description information of the video content object, and the at least one piece of media content, which further enriches the way of generating a video and improves the user’s experience on video generation operations.

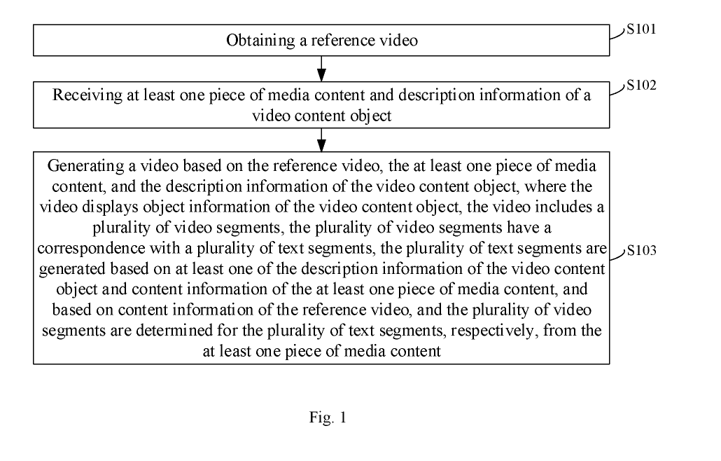

Based on this, the embodiments of the present disclosure provide a video generation method. FIG. 1 is a flowchart of a video generation method provided by the embodiments of the present disclosure. The method specifically includes the following steps.

S101: obtaining a reference video.

The video generation method provided by the embodiments of the present disclosure may be applied to a client. For example, the client may include a client deployed on a smart phone, a client deployed on a tablet computer, etc.

The reference video may be a video resource that provides reference and imitation examples, and the reference video has a reference function, that is, a video can be created by imitating a text structure, an expression way, an editing effect, etc. of the reference video based on the reference video.

There are multiple ways to obtain the reference video. In an optional implementation, the reference video may be obtained through video link information entered by a user. Specifically, the video link information entered by the user is received, and the reference video is obtained according to a video address corresponding to the video link information. The video link information identifies an obtaining address of the reference video, for example, the video link information may be a website address.

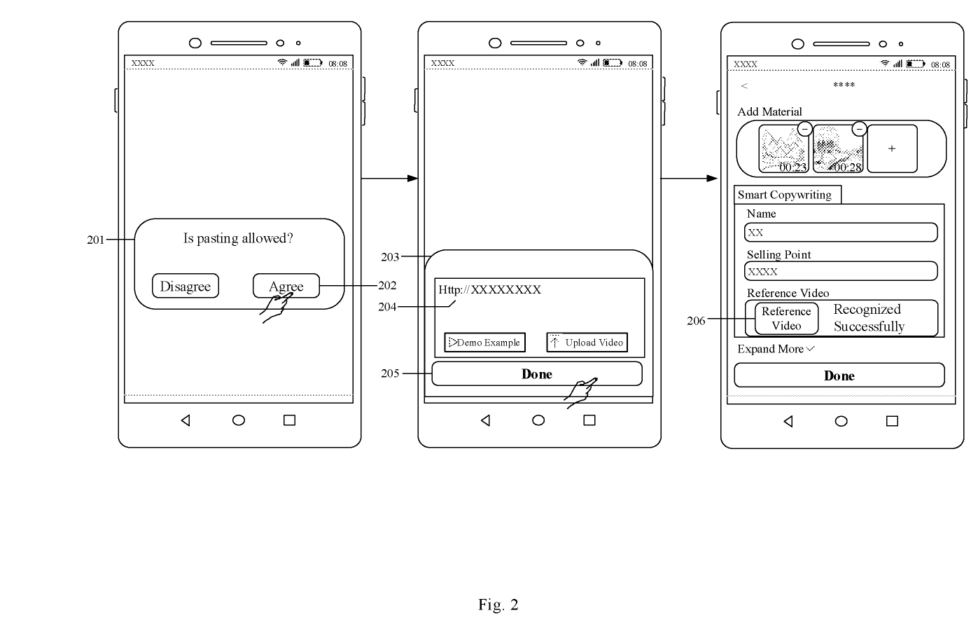

FIG. 2 is a schematic diagram of a video generation page provided by the embodiments of the present disclosure. In the figure, video pasting prompt information 201 is displayed on a current page, and when an agree control 202 in the video pasting prompt information is received, a video obtaining page 203 is displayed, where the video obtaining page is used to display video link information. When video link information 204 is received, a reference video is obtained according to a video address corresponding to the video link information. Obtaining complete 205 is further displayed on the video obtaining page, and when a trigger operation for the obtaining complete control 205 is received, the video obtaining page is closed, and a reference video 206 corresponding to the video link information is displayed on the video generation page.

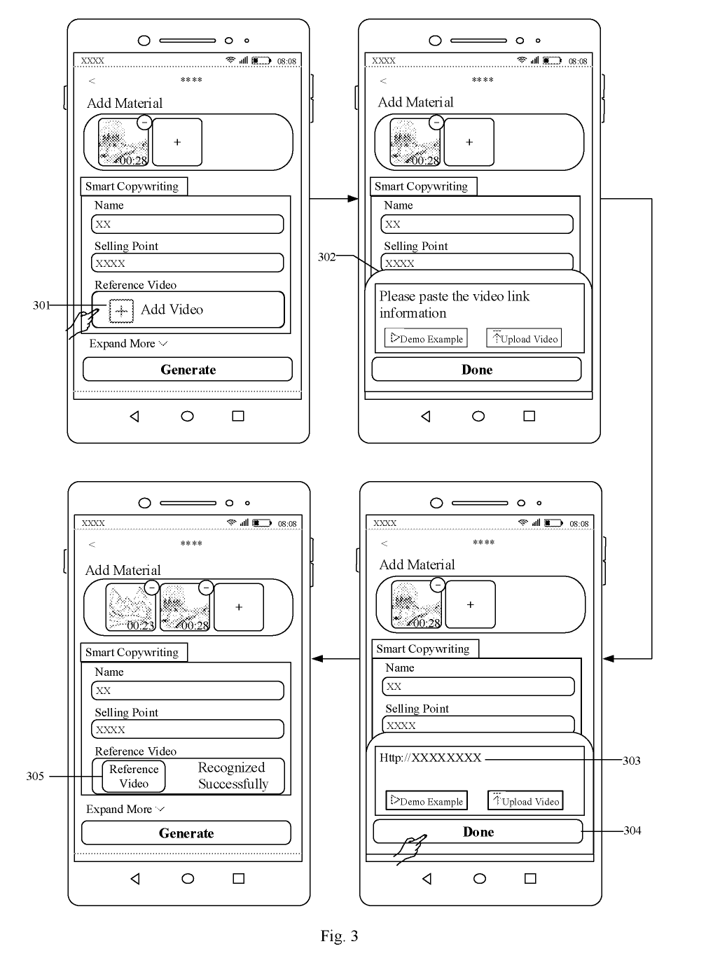

FIG. 3 is a schematic diagram of another video generation page provided by the embodiments of the present disclosure. In the figure, a video adding control 301 is displayed on the video generation page, and when a trigger operation for the video adding control 301 is received, a video obtaining page 302 is displayed on the video generation page, where the video obtaining page 302 is used to enter video link information. When an input operation of video link information 303 is received and an obtaining complete control 304 on the video obtaining page is triggered, the video obtaining page is closed, and a reference video 305 obtained based on the video link information is displayed on the video generation page.

On the basis of the above embodiments, in the process of displaying the video obtaining page, if the current user does not select a reference video that satisfies a requirement, a reference video for the current video generation operation may be obtained through a preset material control set on the video obtaining page. Specifically, when a trigger operation for the preset material control on the video obtaining page is received, a video play page is displayed, and video content of a preset material and a use control are played on the video play page; and when a trigger operation for the use control is received, the preset material is displayed on the video generation page as the reference video. The preset material control is used to trigger the playing of the preset material, and the preset material is a preset and configured material.

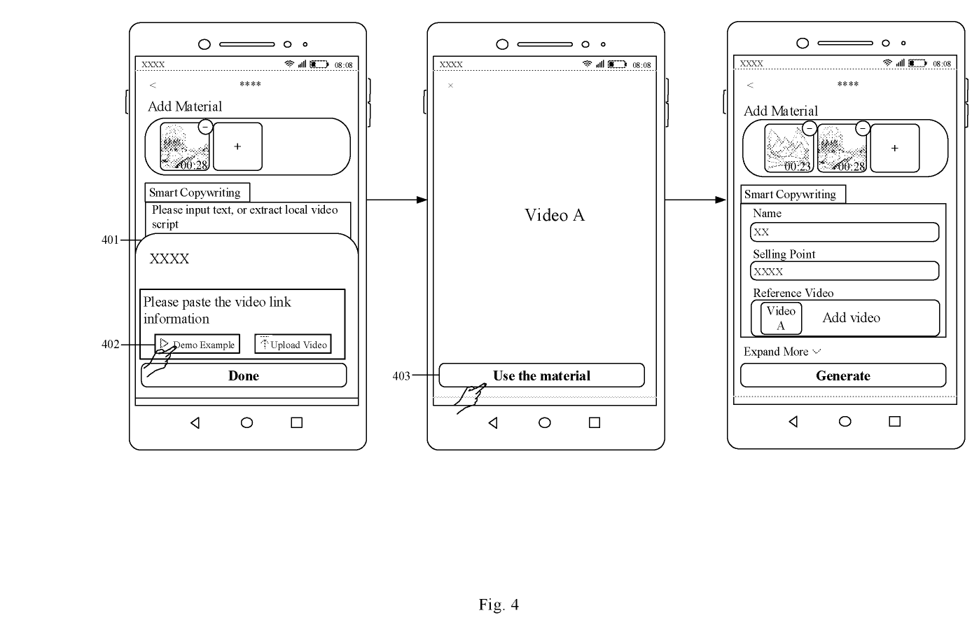

FIG. 4 is a schematic diagram of a video generation page provided by the embodiments of the present disclosure. In the figure, a video obtaining page 401 is displayed on the video generation page, and a preset material control 402 is displayed on the video obtaining page. When a trigger operation for the preset material control 402 is received, a video play page is displayed, and video content of a preset material is played on the video play page. A use control 403 is further displayed on the video play page, and when a trigger operation for the use control is received, the preset material is displayed on the video generation page as a reference video.

In another optional implementation, if a user downloads a reference video to a local place in advance, the reference video may be obtained by uploading a video. Specifically, a video generation page is displayed first, and a video adding control is displayed on the video generation page. When a trigger operation for the video adding control is received, a video obtaining page is displayed, and a video upload control is displayed on the video obtaining page. When a trigger operation for the video upload control is received, a first page is displayed, where the first page is used to display a plurality of pieces of video content. Then, first video content is selected from the plurality of pieces of video content displayed on the first page, and a reference video is obtained based on the first video content. The video content on the first page may include video content downloaded by the user.

The first page may be a user material page, and the first video content may be any piece of video content displayed on the user material page.

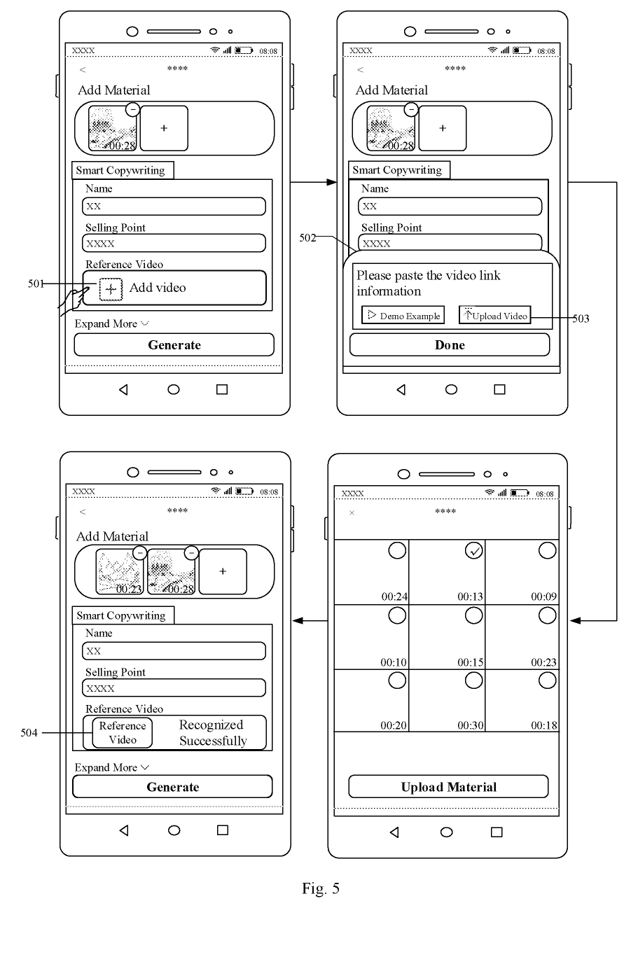

FIG. 5 is a schematic diagram of a video generation page provided by the embodiments of the present disclosure. In the figure, a video adding control 501 is displayed on the video generation page, and when a trigger operation for the video adding control 501 is received, a video obtaining page 502 is displayed on the video generation page, where a video upload control 503 is displayed on the video obtaining page. When a trigger operation for the video upload control 503 is received, a user material page is displayed, and when a selection operation for first video content and a trigger operation for a material upload control are received, the first video content is displayed on the video generation page as a reference video, as shown by 504.

S102: receiving at least one piece of media content and description information of a video content object.

The media content may be one or more pieces of media content uploaded by a user, and the media content may include media materials of multiple media types. Specifically, the media type of the media content may be an audio-type media material, a picture-type media material, etc.

In an optional implementation, the media content may be obtained from a user album. Specifically, the media content may be obtained by a user triggering a material upload control to display a user album page.

The video content object in the embodiments of the present disclosure is a main object in a video generated in the current generation operation. In other words, the video content object is a main described object of the generated video. The video content object may include a commodity object. The description information of the video content object may be related feature information of the video content object, that is, the description information describes the video content object. The description information may include information in multiple forms, specifically, the description information may include description information in a text form, and may also include description information in a speech form.

In an optional implementation, the description information of the video content object may be received by entering text content corresponding to an attribute of the video content object. The attribute may be, for example, a name, a feature, a selling point, an advantage, an applicable crowd, a preferential activity, a video duration, or a video ratio of the video content object.

Specifically, first text content is entered for a first attribute of the video content object on the video generation page, candidate recommended text of a second attribute of the video content object is displayed based on the first text content, and then at least one piece of candidate recommended text is selected from the candidate recommended text as second text content corresponding to the second attribute. Then, the first text content and the second text content corresponding to the first attribute and the second attribute, respectively, are used as the description information of the video content object. The first attribute and the second attribute are any two different attributes of the video content object.

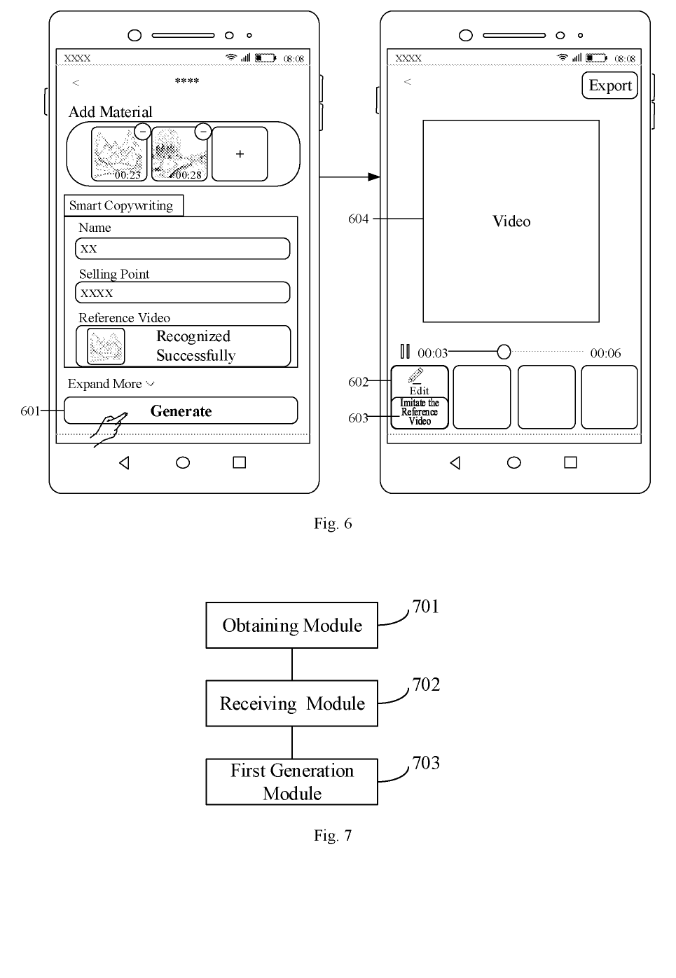

FIG. 6 is a schematic diagram of a video generation page provided by the embodiments of the present disclosure. Attributes such as a "name" and a "selling point" of a video content object are displayed on the video generation page.

S103: generating a video based on the reference video, the at least one piece of media content, and the description information of the video content object.

The video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

The video in the embodiments of the present disclosure contains object information of the video content object, and the object information may include information such as a name, an applicable crowd, a preference, and a resource attribute value of the video content object.

The video may be a video file or a video draft, and the video draft may be a draft-format video generated in a video editing stage. The video draft includes an editing effect resource of the video, etc., and the editing effect resource may be displayed in a track form on a video editing page according to a resource type. The video file may be a file generated by triggering the export of the video draft, and the video file can be used for publishing.

The similarity between the video and the reference video exceeds a threshold, and the threshold is a preset similarity value. Specifically, the video may present a text style, an expression way, a text structure, etc. of the reference video, that is, the video may be generated based on the text style, the expression way, the text structure, etc. of the reference video.

In an optional implementation, part or all of video editing effects of the reference video may be presented in the video. The video editing effects may include video editing effects in the reference video, such as decorative text effects, stickers, filters, key frames, and transition animations.

To characterize the relationship between the video and the reference video, in the embodiments of the present disclosure, when the video is generated, a preset tag may be added to the video, where the preset tag is used to prompt that the similarity between the video and the reference video exceeds a threshold, and the threshold is a preset similarity value. As shown in FIG. 6, a preset tag 603 is displayed on a display video 602 on the video generation page, and the preset tag is used to characterize that the similarity between the video 602 and the reference video exceeds a threshold.

In practical applications, to generate a video that satisfies users’ requirements, in the embodiments of the present disclosure, a plurality of videos may be generated based on the reference video, the media content, and the description information of the video content object, where the plurality of videos include at least one video whose similarity with the reference video exceeds a threshold.

The trigger operation for generating the video may include a trigger operation for a video generation control. Specifically, the video generation control is displayed on the video generation page, and when the video generation control is received, the operation of generating the video is triggered.

As shown in FIG. 6, a video generation control 601 is displayed on the video generation page, and when a trigger operation for the video generation control 601 is received, a video is generated based on the reference video, the media content, and the description information of the video content object.

In addition, to be convenient for displaying the video content of the video to the user, so as to be convenient for the user to perform subsequent editing operations on the video, in the embodiments of the present disclosure, the video content of the video may also be played in a video window of the video generation page. As shown in FIG. 6, a video window 604 is displayed on the video generation page, and the video content of the video 602 can be played in the video window.

The video is formed by concatenating a plurality of video segments. If a plurality of videos are generated based on the reference video, the media content, and the description information of the video content object, the plurality of generated videos may include the same or different video segments, may include the same or different numbers of video segments, and may have the same or different video durations. The video segments included in the video have a correspondence with text segments, that is, each video segment has a corresponding text segment. Specifically, the text segment may be generated based on at least one of the description information of the video content object and content information of the media content, and based on content information of the reference video, and the content information of the media content is content information obtained by analyzing and extracting the media content. The content information of the reference video may be content information obtained by analyzing and extracting the reference video.

In an optional implementation, after the reference video, the media content, and the description information of the video content object are determined, a video can be generated based on the reference video, the media content, and the description information of the video content object. Specifically, speech recognition and/or image recognition are performed on the reference video first to obtain a script recognition result of the reference video, and then a video script is generated based on at least one of the description information of the video content object and content information extracted from the media content, and based on the script recognition result of the reference video. After the video script is obtained, corresponding video segments are determined for a plurality of text segments corresponding to the video script, respectively, from the media content, and then a video is generated based on the plurality of video segments.

The script recognition result describes a paragraph structure of script content of the reference video. The script recognition result may include features such as a text structure, a text style, an expression way, and video editing effects of the reference video. Specifically, a speech recognition tool and/or an image recognition tool may be used to perform speech recognition on the reference video to obtain the text structure, the text style, the expression way, etc. of the reference video, and perform image recognition on the reference video to obtain the video editing effects, etc. of the reference video.

In an optional implementation, a script generation model may be used to generate a video script based on at least one of the description information of the video content object and the content information extracted from the media content, and based on the script recognition result of the reference video, where the script generation model is used to generate the video script, and the script generation model may be obtained by training a training sample. Specifically, the description information of the video content object, the content information of the media content, and the script recognition result may be used as input parameters and input into the script generation model, and the video script is output after being processed by the script generation model. The video script may have the same text structure, text style, and expression way as the reference video. The embodiments of the present disclosure impose no limitation on the manner of extracting the content information from the media content.

The text segments corresponding to the video script may be obtained by performing text segmentation on the video script. The plurality of text segments have a preset order relationship, and the preset order relationship may include a paragraph relationship, a context relationship, etc.

After the plurality of text segments corresponding to the video script are obtained, the video segments corresponding to the plurality of text segments may be concatenated based on the preset order relationship between the text segments to obtain the video draft. That is, the presentation order of the plurality of video segments included in the video is determined based on the preset order relationship between the plurality of corresponding text segments.

The video segment corresponding to the text segment may be obtained by cutting the media content. Specifically, content feature recognition may be performed on each piece of media content to determine a feature segment having a content feature in each piece of media content, and then, the feature segment is cut from each piece of media material based on the feature segment, and the text segment corresponding to the feature segment is determined from the plurality of text segments. The feature segment having the content feature may include a segment with high video content quality, and specifically, the feature segment may be, for example, a highlight segment.

In practical applications, because one text segment may match a plurality of feature segments, in the case where one text segment matches a plurality of feature segments, a corresponding feature segment may be determined for the text segment based on the matching degree between the text segment and each feature segment. Specifically, the matching degree between the text segment and each of the feature segments is calculated, and then a segment with a high matching degree is determined as the feature segment corresponding to the text segment. The higher the matching degree between the feature segment and the text segment, the higher the degree of fit between the feature segment and the text segment. The embodiments of the present disclosure impose no limitation on the manner of calculating the matching degree between the feature segment and the text segment.

In the video generation method provided by the embodiments of the present disclosure, first, a reference video is obtained, and at least one piece of media content and description information of a video content object are received; then, a video is generated based on the reference video, the at least one piece of media content, and the description information of the video content object. The video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

In the embodiments of the present disclosure, the video may be generated based on the reference video, the description information of the video content object, and the at least one piece of media content, which further enriches the way of generating a video and improves the user’s experience on video generation operations.

In an optional implementation, to further improve the user experience, a voice-over function may also be added to the generated video. Specifically, after a video script is generated based on at least one of the description information of the video content object and content information extracted from the media content, and based on the script recognition result of the reference video, and a plurality of text segments are obtained by cutting the video script, a speech segment is generated for the video segment corresponding to each text segment, where the speech segment and the video segment have the same playing time information, that is, the speech segment is synchronized with the video segment. The plurality of text segments may be read by a voice to generate speech segments corresponding to the plurality of video segments.

Then, the video segments having the speech segments are concatenated based on the preset order relationship corresponding to the plurality of text segments to obtain a video.

In another optional implementation, to enable the generated video to have the relevant features of the reference video to satisfy the user’s requirements, the timbre information of the reference video may also be added to the video.

Specifically, after a video script is generated based on at least one of the description information of the video content object and content information extracted from the media content, and based on the script recognition result of the reference video, a plurality of text segments are obtained by cutting the video script, and corresponding video segments are determined for the plurality of text segments, timbre recognition is performed on the reference video to obtain timbre information of the reference video, and then, based on the timbre information and the plurality of text segments, speech segments are generated for the video segments respectively corresponding to the plurality of text segments, and then a video is generated based on the video segments and the speech segments corresponding to the video segments, where the speech segments have the timbre information of the reference video.

On the basis of the preceding embodiments, in the embodiments of the present disclosure, background music may also be added to the video based on music information of the reference video. Specifically, music recognition is performed on the obtained reference video to obtain the music information of the reference video, and then the background music is added to the video based on the music information. The similarity between the background music of the video and the background music of the reference video exceeds a threshold. For example, the background music of the video may be the same as the background music of the reference video, or the style of the background music of the video is the same as the style of the background music of the reference video.

In the embodiments of the present disclosure, the music information and the timbre information of the reference video are obtained, so that the similarity between the generated video and the reference video may be higher, to further satisfy the user’s requirements and improve the user experience.

Based on the preceding method embodiments, the present disclosure further provides a video generation apparatus. FIG. 7 is a schematic structural diagram of a video generation apparatus provided by the embodiments of the present disclosure. The apparatus includes:

an obtaining module 701, configured to obtain a reference video;

a receiving module 702, configured to receive at least one piece of media content and description information of a video content object; and

a first generation module 703, configured to generate a video based on the reference video, the at least one piece of media content, and the description information of the video content object,

where the video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

In an optional implementation, part or all of video editing effects of the reference video are presented in a video draft.

In an optional implementation, the first obtaining module is further configured to:

receive video link information entered by a user, and obtain the reference video based on the video link information.

In an optional implementation, the first obtaining module is further configured to:

display a first page, and obtain the reference video based on a plurality of pieces of video content displayed on the first page.

In an optional implementation, the first generation module includes:

an obtaining sub-module, configured to obtain a script recognition result of the reference video by performing at least one of speech recognition and image recognition on the reference video, where the script recognition result describes a paragraph structure of script content of the reference video;

a first generation sub-module, configured to generate a video script based on at least one of the description information of the video content object and content information extracted from the at least one piece of media content, and based on the script recognition result of the reference video;

a first determination sub-module, configured to determine corresponding video segments for a plurality of text segments corresponding to the video script, respectively, from the at least one piece of media content; and

a second generation sub-module, configured to generate the video based on the video segments respectively corresponding to the plurality of text segments.

In an optional implementation, the apparatus further includes:

a first recognition module, configured to perform timbre recognition on the reference video to obtain timbre information of the reference video; and

a second generation sub-module, configured to generate, based on the timbre information and a text segment, a speech segment for a video segment corresponding to the text segment, where the speech segment has the timbre information,

and the second generation sub-module is further configured to:

generate the video based on the video segments respectively corresponding to the plurality of text segments, and a plurality of speech segments corresponding to the video segments.

In an optional implementation, the apparatus further includes:

a second recognition module, configured to perform music recognition on the reference video to obtain music information of the reference video; and

an adding module, configured to add background music to the video based on the music information.

In an optional implementation, the apparatus further includes:

a segmentation module, configured to perform text segmentation on the video script to obtain the plurality of text segments corresponding to the video script, where the plurality of text segments have a preset order relationship.

In an optional implementation, the first determination sub-module includes:

a cutting sub-module, configured to cut the corresponding video segments for the plurality of text segments, respectively, from the at least one piece of media content,

and the second generation sub-module is further configured to:

concatenate the video segments respectively corresponding to the plurality of text segments to obtain the video based on the preset order relationship.

In an optional implementation, the cutting sub-module includes:

a recognition sub-module, configured to perform content feature recognition on the at least one piece of media content, respectively, to determine a feature segment having a content feature in the at least one piece of media content; and

a second determination sub-module, configured to cut at least one feature segment from the at least one piece of media content, and determine a text segment corresponding to the feature segment from the plurality of text segments.

In an optional implementation, the apparatus further includes:

a second generation module, configured to generate, based on a text segment, a speech segment for a video segment corresponding to the text segment,

and the second generation sub-module is further configured to:

concatenate the video segments respectively corresponding to the plurality of text segments and having the speech segment to obtain the video based on the preset order relationship.

In the video generation apparatus provided by the embodiments of the present disclosure, firstly, a reference video is obtained, and at least one piece of media content and description information of a video content object are received; then, a video is generated based on the reference video, the at least one piece of media content, and the description information of the video content object. The video displays object information of the video content object, the video includes a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

In the embodiments of the present disclosure, the video may be generated based on the reference video, the description information of the video content object, and the at least one piece of media content, which further enriches the way of generating a video and improves the user’s experience on video generation operations.

In addition to the preceding methods and apparatuses, the embodiments of the present disclosure further provide a computer-readable storage medium, where instructions are stored in the computer-readable storage medium, and the instructions, when executed by a terminal device, cause the terminal device to implement the video generation method according to the embodiments of the present disclosure.

The embodiments of the present disclosure further provide a computer program product, including a computer program/instruction, where the computer program/instruction, when executed by a processor, implements the video generation method according to the embodiments of the present disclosure.

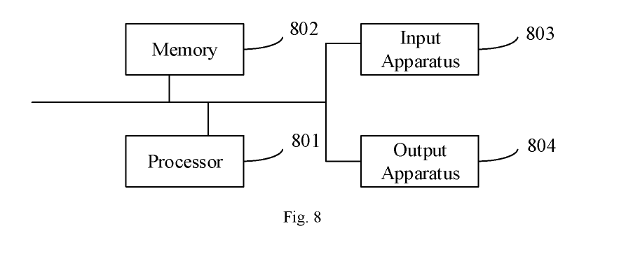

In addition, the embodiments of the present disclosure further provide a video generation device, which, as shown in FIG. 8, includes a processor 801, a memory 802, an input apparatus 803, and an output apparatus 804.

The number of the processor 801 in the video generation device may be one or more, and in FIG. 8, one processor is used as an example. In some embodiments of the present disclosure, the processor 801, the memory 802, the input apparatus 803, and the output apparatus 804 may be connected through a bus or in other manners, and in FIG. 8, connection through a bus is used as an example.

The memory 802 may be used to store software programs and modules, and the processor 801 executes various functional applications and data processing of the video generation device by running the software programs and modules stored in the memory 802. The memory 802 may mainly include a program storage area and a data storage area, where the program storage area may store an operating system, applications required by at least one function, etc. In addition, the memory 802 may include high-speed random-access memory, and may also include non-volatile memory, such as at least one magnetic disk storage device, flash memory device, or other volatile solid-state storage devices. The input apparatus 803 may be used to receive input digital or character information, and generate signal input related to user settings and function control of the video generation device.

Specifically, in this embodiment, the processor 801 may load an executable file corresponding to a process of one or more applications into the memory 802 according to the following instructions, and the processor 801 runs the applications stored in the memory 802 to implement various functions of the preceding video generation device.

It should be noted that in this paper, relational terms such as "first" and "second" are only used to distinguish one entity or operation from another entity or operation, and do not necessarily require or imply any actual relationship or order between these entities or operations. Moreover, terms "include", "include" or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by phrase "including a" does not exclude that there are other identical elements in the process, method, object or device including the element.

The preceding descriptions are only specific implementations of the present disclosure, so that those skilled in the art may understand or implement the present disclosure. Various modifications to these embodiments will be obvious to those skilled in the art, and general principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

1. A video generation method, comprising:
obtaining a reference video;
receiving at least one piece of media content and description information of a video content object; and
generating a video based on the reference video, the at least one piece of media content, and the description information of the video content object,
wherein the video displays object information of the video content object, the video comprises a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

2. The video generation method according to claim 1, wherein part or all of video editing effects of the reference video are presented in the video.

3. The video generation method according to claim 1, wherein the obtaining the reference video comprises:
receiving video link information entered by a user, and obtaining the reference video based on the video link information.

4. The video generation method according to claim 1, wherein the obtaining the reference video comprises:
displaying a first page, and obtaining the reference video based on a plurality of pieces of video content displayed on the first page.

5. The video generation method according to claim 1, wherein the generating the video based on the reference video, the at least one piece of media content, and the description information of the video content object comprises:
obtaining a script recognition result of the reference video by performing at least one of speech recognition and image recognition on the reference video, wherein the script recognition result describes a paragraph structure of script content of the reference video;
generating a video script based on at least one of the description information of the video content object and content information extracted from the at least one piece of media content, and based on the script recognition result of the reference video;
determining corresponding video segments for a plurality of text segments corresponding to the video script, respectively, from the at least one piece of media content; and
generating the video based on the video segments respectively corresponding to the plurality of text segments.

6. The video generation method according to claim 5, wherein before the generating the video based on the video segments respectively corresponding to the plurality of text segments, the video generation method further comprises:
performing timbre recognition on the reference video to obtain timbre information of the reference video; and
generating, based on the timbre information and a text segment, a speech segment for a video segment corresponding to the text segment, wherein the speech segment has the timbre information;
and the generating the video based on the video segments respectively corresponding to the plurality of text segments comprises:
generating the video based on the video segments respectively corresponding to the plurality of text segments, and a plurality of speech segments corresponding to the video segments.

7. The video generation method according to claim 1, wherein after the generating the video based on the reference video, the at least one piece of media content, and the description information of the video content object, the video generation method further comprises:
performing music recognition on the reference video to obtain music information of the reference video; and
adding background music to the video based on the music information.

8. The video generation method according to claim 5, wherein before the determining the corresponding video segments for the plurality of text segments corresponding to the video script, respectively, from the at least one piece of media content, the video generation method further comprises:
performing text segmentation on the video script to obtain the plurality of text segments corresponding to the video script, wherein the plurality of text segments have a preset order relationship.

9. The video generation method according to claim 8, wherein the determining the corresponding video segments for the plurality of text segments corresponding to the video script, respectively, from the at least one piece of media content comprises:
cutting the corresponding video segments for the plurality of text segments, respectively, from the at least one piece of media content;
and the generating the video based on the video segments respectively corresponding to the plurality of text segments comprises:
concatenating the video segments respectively corresponding to the plurality of text segments to obtain the video based on the preset order relationship.

10. The video generation method according to claim 9, wherein the cutting the corresponding video segments for the plurality of text segments, respectively, from the at least one piece of media content comprises:
performing content feature recognition on the at least one piece of media content, respectively, to determine a feature segment having a content feature in the at least one piece of media content; and
cutting at least one feature segment from the at least one piece of media content, and determining a text segment corresponding to the feature segment from the plurality of text segments.

11. The video generation method according to claim 9, wherein before the concatenating the video segments respectively corresponding to the plurality of text segments to obtain the video based on the preset order relationship, the video generation method further comprises:
generating, based on a text segment, a speech segment for a video segment corresponding to the text segment,
and the concatenating the video segments respectively corresponding to the plurality of text segments to obtain the video based on the preset order relationship comprises:
concatenating the video segments respectively corresponding to the plurality of text segments and having the speech segment to obtain the video based on the preset order relationship.

12. A non-transitory computer-readable storage medium, wherein instructions are stored in the computer-readable storage medium, and the instructions, when executed by a terminal device, cause the terminal device to implement a video generation method, and the video generation method comprises:
obtaining a reference video;
receiving at least one piece of media content and description information of a video content object; and
generating a video based on the reference video, the at least one piece of media content, and the description information of the video content object,
wherein the video displays object information of the video content object, the video comprises a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

13. A video generation device, comprising a memory, a processor, and a computer program stored on the memory and executable on the processor, wherein the processor, when executing the computer program, implements a video generation method, and the video generation method comprises:
obtaining a reference video;
receiving at least one piece of media content and description information of a video content object; and
generating a video based on the reference video, the at least one piece of media content, and the description information of the video content object,
wherein the video displays object information of the video content object, the video comprises a plurality of video segments, the plurality of video segments have a correspondence with a plurality of text segments, the plurality of text segments are generated based on at least one of the description information of the video content object and content information of the at least one piece of media content, and based on content information of the reference video, and the plurality of video segments are determined for the plurality of text segments, respectively, from the at least one piece of media content.

14. The video generation device according to claim 13, wherein part or all of video editing effects of the reference video are presented in the video.

15. The video generation device according to claim 13, wherein the obtaining the reference video comprises:
receiving video link information entered by a user, and obtaining the reference video based on the video link information.

16. The video generation device according to claim 13, wherein the obtaining the reference video comprises:
displaying a first page, and obtaining the reference video based on a plurality of pieces of video content displayed on the first page.

17. The video generation device according to claim 13, wherein the generating the video based on the reference video, the at least one piece of media content, and the description information of the video content object comprises:
obtaining a script recognition result of the reference video by performing at least one of speech recognition and image recognition on the reference video, wherein the script recognition result describes a paragraph structure of script content of the reference video;
generating a video script based on at least one of the description information of the video content object and content information extracted from the at least one piece of media content, and based on the script recognition result of the reference video;
determining corresponding video segments for a plurality of text segments corresponding to the video script, respectively, from the at least one piece of media content; and
generating the video based on the video segments respectively corresponding to the plurality of text segments.

18. The video generation device according to claim 17, wherein before the generating the video based on the video segments respectively corresponding to the plurality of text segments, the video generation method further comprises:
performing timbre recognition on the reference video to obtain timbre information of the reference video; and
generating, based on the timbre information and a text segment, a speech segment for a video segment corresponding to the text segment, wherein the speech segment has the timbre information;
and the generating the video based on the video segments respectively corresponding to the plurality of text segments comprises:
generating the video based on the video segments respectively corresponding to the plurality of text segments, and a plurality of speech segments corresponding to the video segments.

19. The video generation device according to claim 13, wherein after the generating the video based on the reference video, the at least one piece of media content, and the description information of the video content object, the video generation method further comprises:
performing music recognition on the reference video to obtain music information of the reference video; and
adding background music to the video based on the music information.

20. The video generation device according to claim 17, wherein before the determining the corresponding video segments for the plurality of text segments corresponding to the video script, respectively, from the at least one piece of media content, the video generation method further comprises:
performing text segmentation on the video script to obtain the plurality of text segments corresponding to the video script, wherein the plurality of text segments have a preset order relationship.
